(19) United States
(12) Patent Application Publication
(10) Pub. No.: US 2006/0213542 A1
(43) Pub. Date: Sep. 28, 2006

(54) Substrate processing apparatus

(75) Inventors: Yoshitaka Abiko, Kyoto (JP); Seiji Sano, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg., Co., Ltd.

(21) Appl. No.: 11/389,735

(22) Filed: Mar. 27, 2006

(30) Foreign Application Priority Data
Mar. 28, 2005 (JP) JP2005-092159
Jan. 31, 2006 (JP) JP2006-022309

(51) Int. Cl. B08B 3/00

(52) U.S. Cl. 134/61; 134/66; 134/902

(57) ABSTRACT

A plurality of substrates after subjected to a chemical solution processing in a second processing bath is immersed in deionized water stored in a first processing bath. At this time, a holding mechanism is moved down such that the positions in the height direction of two holding bars among three holding bars, which are disposed on a deionized water nozzle side, are substantially the same as that of an upper deionized water nozzle. A lower deionized water nozzle keeps supplying deionized water, so that deionized water overflows an internal bath toward an external bath. Subsequently, to the two holding bars, the corresponding upper deionized water nozzles expel deionized water. This applies a sufficiently strong steam of water to the two holding bars, so that a residue adhered to holding grooves of these holding bars can be cleaned well. A holding groove of the rest holding bar can be cleaned well by a stream of water that can be formed by deionized water supplied from a lower deionized nozzle.

### BACKGROUND OF THE INVENTION

1. Field of the Invention

The present invention relates to a substrate processing apparatus that performs a processing such as etching and cleaning by immersing a semiconductor wafer, a glass substrate for a liquid crystal display, a glass substrate for a photomask, a substrate for an optical disk, and the like (which are hereinafter referred to simply as a “substrate”) in a processing solution such as a chemical solution, deionized water, or the like stored in a processing bath.

2. Description of the Background Art

Conventionally, there has been known an apparatus that performs a predetermined processing of a substrate by shifting it between a plurality of processing baths by a lifter.

In a conventional substrate processing apparatus, however, when a substrate after being subjected to a processing with a chemical solution such as hydrofluoric acid, buffer hydrofluoric acid (BHF), etc. is transported from a processing bath for a chemical solution process to a processing bath for a deionized water rinse processing, the chemical solution may remain in a holding groove of a holding bar of the lifter in some cases. If the deionized water rinse processing fails to sufficiently clean the residual chemical solution, there may arise the problem that the residual chemical solution becomes a source of particles thereby to cause poor processing of the substrate.

This problem is not limited to the above case. For example, a similar problem may arise by a chemical solution remaining in a holding groove of a lifter holding part in a multifunction bath that stores a chemical solution or deionized water to perform various chemical solution processes and cleaning process in a single bath.

### SUMMARY OF THE INVENTION

The present invention is directed to a substrate processing apparatus for performing a processing of a substrate.

According to the present invention, a substrate processing apparatus includes a first processing bath for storing deionized water; a second processing bath for storing a chemical solution; a holding mechanism that has a plurality of holding grooves for holding a plurality of substrates, and that can shift from the inside of the second processing bath to the inside of the first processing bath, while holding a plurality of substrates by the holding grooves; a first supply part for supplying deionized water into the first processing bath; and a second supply part for expelling deionized water to the holding grooves of the holding mechanism present in the first processing bath.

The second supply part expels deionized water to the holding grooves of the holding mechanism present in the first processing bath. This suppresses particle generation resulting from the chemical solution remaining in the holding grooves, thereby preventing poor processing of the substrates.

Preferably, there is further provided with a holding part that is disposed above the second supply part in the first processing bath, and that holds a plurality of substrates transferred from the holding mechanism. With a plurality of substrates held by the holding part, the second supply part expels deionized water to the holding grooves of the holding mechanism.

The presence of a gap between the holding grooves and the substrates can ensure expelling of deionized water to the holding grooves, and suppression of particles resulting from the chemical solution remaining in the holding grooves.

Preferably, there is further provided with a holding part that is disposed in the first processing bath and holds a plurality of substrates transferred from the holding mechanism. With a plurality of substrates held by the holding part, the second supply part expels deionized water from an upper side of the holding grooves of the holding mechanism to the holding grooves.

Since deionized water can be expelled from the upper side of the holding grooves that hold no substrate, the chemical solution remaining in the holding grooves can be eliminated. This enhances suppression of particle generation resulting from the chemical solution, and prevention of poor processing of the substrates.

According to one aspect of the present invention, a substrate processing apparatus has a processing bath for storing a processing solution, a holding mechanism that has a plurality of holding grooves for holding a plurality of substrates and is contained in the processing bath, a first supply part for expelling a processing solution into the processing bath, and a second supply part for expelling a processing solution to the holding grooves of the holding mechanism present in the processing bath.

The second supply part expels a processing solution to the holding grooves of the holding mechanism present in the processing bath. This eliminates particles remaining in the holding grooves thereby to prevent poor processing of the substrates.

Preferably, there is further provided with a holding part that is disposed above the second supply part in the processing bath and holds a plurality of substrates transferred from the holding mechanism. With a plurality of substrates held by the holding part, the second supply part expels a processing solution to the holding grooves of the holding mechanism.

The presence of a gap between the holding grooves and the substrates can ensure expelling of a processing solution to the holding grooves and suppression of particles remaining in the holding grooves.

Preferably, there is further provided with a holding part that is disposed in the processing bath and holds a plurality of substrates transferred from the holding mechanism. With a plurality of substrates held by the holding part, the second supply part can expel deionized water from an upper side of the holding grooves of the holding mechanism to the holding grooves.

Since deionized water can be expelled from the upper side of the holding grooves that hold no substrate, the chemical solution remaining in the holding grooves can be removed better. This further suppresses particle generation resulting from the chemical solution, enhancing suppression of poor processing of a substrate.

According to other aspect of the present invention, a substrate processing apparatus includes a first processing bath for storing deionized water; a second processing bath for storing a chemical solution; a holding mechanism that has a plurality of holding grooves for holding a plurality of substrates, that can shift from the inside of the second processing bath to the inside of the first processing bath, while holding a plurality of substrates held by the holding grooves, and that can move up and down in the first processing bath; a supply part for supplying deionized water into the first processing bath; and a holding part that is disposed above the supplying part in the first processing bath and holds a plurality of substrates transferred from the holding mechanism. With the holding mechanism holding a plurality of substrates immersed in deionized water stored in the first processing bath, a state in which the plurality of substrates are held by the holding grooves, and a state in which they are held by the holding part are repeated by allowing the holding mechanism to move up and down.

An up-and-down movement of the holding mechanism eliminates the chemical solution remaining in the holding grooves. This can suppress particle generation resulting from the chemical solution, thereby preventing poor processing of the substrates.

According to still other aspect of the present invention, a substrate processing apparatus includes a processing bath for storing a processing solution; a holding mechanism that has a plurality of holding grooves for holding a plurality of substrates, and that can move up and down in the processing bath; a supply part for supplying a processing solution into the processing bath; and a holding part that is disposed above the supply part in the processing bath, and holds a plurality of substrates transferred from the holding mechanism. A state in which a plurality of substrates are held by the holding grooves of the holding mechanism, and a state in which they are held by the holding part are repeated by allowing the holding mechanism to move up and down in a state in which the holding mechanism holding a plurality of substrates is immersed in a processing solution stored in the processing bath.

An up-and-down movement of the holding mechanism can eliminate particles remaining in the holding grooves, thereby preventing poor processing of the substrates.

Accordingly, an object of the present invention is to provide a substrate processing apparatus enabling an excellent cleaning process of a substrate after being subjected to a chemical solution process.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall construction of a substrate processing apparatus according to a first preferred embodiment of the present invention;

FIG. 2 is a diagram for the sake of explaining a holding bar of a holding mechanism;

FIG. 3 is a diagram showing the overall construction of a substrate processing apparatus according to a second preferred embodiment of the present invention;

FIG. 4 is a diagram showing the overall construction of a substrate processing apparatus according to a third preferred embodiment of the present invention;

FIGS. 5 and 6 are diagrams for the sake of explaining a cleaning procedure of each holding bar in the third preferred embodiment and a fourth preferred embodiment;

FIG. 7 is a diagram for the sake of explaining a method for cleaning a substrate in the third and fourth preferred embodiments;

FIG. 8 is a diagram showing the overall construction of a substrate processing apparatus according to the fourth preferred embodiment of the present invention;

FIG. 9 is a diagram for the sake of explaining a cleaning procedure of each holding bar in fifth and sixth preferred embodiments of the present invention;

FIG. 10 is a diagram showing the overall construction of a substrate processing apparatus according to a seventh preferred embodiment of the present invention;

FIG. 11 is a diagram for the sake of explaining a cleaning procedure of each holding bar in the seventh preferred embodiment and an eighth preferred embodiment of the present invention; and

FIG. 12 is a diagram showing the overall construction of a substrate processing apparatus according to the eighth preferred embodiment.

### DESCRIPTION OF THE PREFERRED EMBODIMENTS

Preferred embodiments of the present invention will be described below with reference to the accompanying drawings.

### 1. First Preferred Embodiment

<1.1. Construction of Substrate Processing Apparatus>

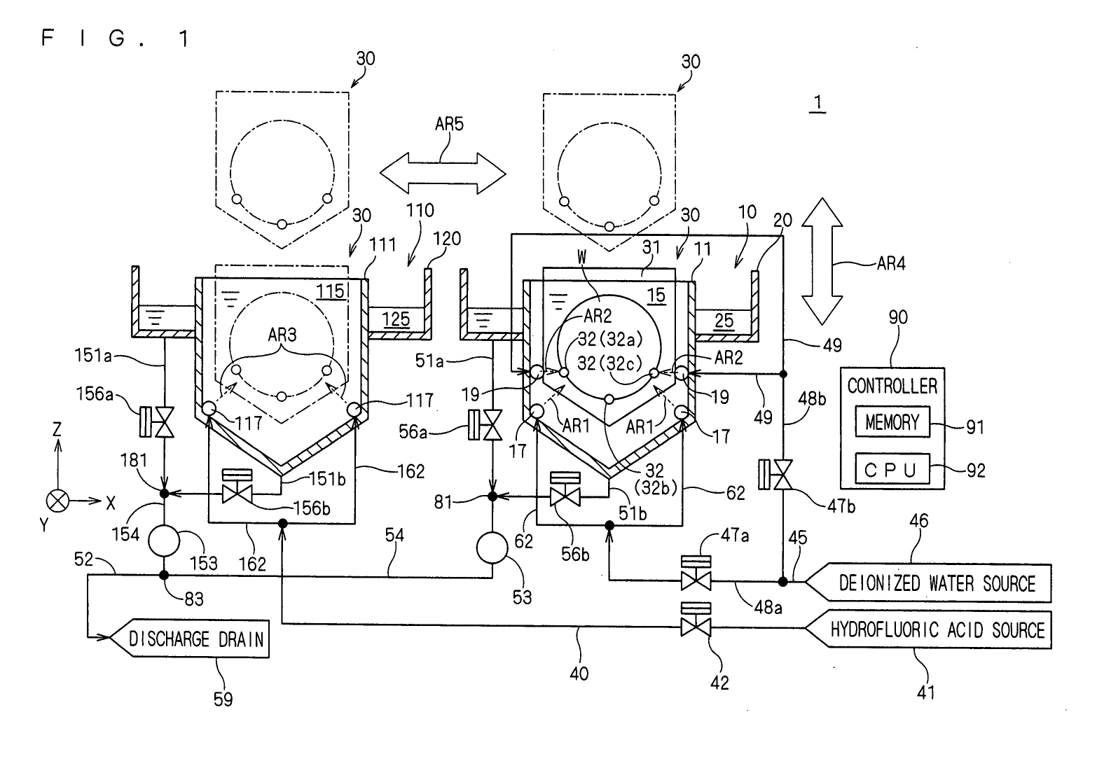

FIG. 1 is a diagram for the sake of explaining the overall construction of a substrate processing apparatus 1 according to a first preferred embodiment of the present invention. The substrate processing apparatus 1 is a so-called “batch processing” apparatus, which performs a substrate processing of a plurality of substrates W at one time. As shown in FIG. 1, the substrate processing apparatus 1 consists mainly of a first processing bath 10, a second processing bath 110, and a holding mechanism 30.

The first processing bath 10 is a bath that subjects a plurality of substrates W to a cleaning process (rinse process) with deionized water by immersing the substrates W in stored deionized water. As shown in FIG. 1, the first processing bath 10 consists mainly of an internal bath 11 and an external bath 20.

The internal bath 11 is a storage bath to store deionized water. By immersing a plurality of substrates W in deionized water 15 stored in the internal bath 11, the plurality of substrates W can be subjected to the same cleaning process at one time.

Disposed in the vicinity of the bottom of the internal bath 11 are two deionized water nozzles 17, through which deionized water is expelled to the inside of the internal bath 11. Each deionized water nozzle 17 is connected in communication to a deionized water source 46 via corresponding branch pipe 62 and piping 48a, and a common piping 45. The piping 48a is provided with a valve 47a that can open and close.

Two deionized water nozzles 19 are disposed on the inside of the internal bath 11, above the deionized water nozzles 17. Each deionized water nozzle 19 is connected in communication to the deionized water source 46 via corresponding branch pipe 49 and piping 48b, and the common piping 45. The piping 48b is provided with a valve 47b that can open and close.

Consequently, with both of the valves 47a and 47b opened, deionized water is expelled from the deionized water nozzles 17 in the direction indicated by the arrow AR1, and from the deionized nozzles 19 in the direction indicated by the arrow AR2. With the valve 47a opened and the valve 47b closed, deionized water is supplied from the deionized water nozzles 17 to the inside of the internal bath 11. With the valve 47b opened and the valve 47a closed, deionized water is supplied from the deionized water nozzles 19 to the inside of the internal bath 11.

Thus, in the internal bath 11 of the first processing bath 10, a cleaning process (rinse process) can be carried out with deionized water supplied from the deionized water nozzles 17 and the deionized water nozzles 19.

In the first preferred embodiment the deionized water nozzles 17 are used mainly for supplying deionized water stored in the internal bath 11, and the deionized water nozzles 19 are used mainly for expelling deionized water to clean holding bars 32 (32a, 32c) of the holding mechanism 30 to be described later.

The external bath 20 is a recovery bath disposed so as to surround an upper end part of the internal bath 11, as shown in FIG. 1. This enables the external bath 20 to recover deionized water supplied to and overflowing the internal bath 11.

When the deionized water used in a cleaning process in the first processing bath 10 is drained as a solution to be discharged, this solution to be discharged is drained to a discharge drain 59 that is placed outside of the substrate processing apparatus 1, and is used as a common facility in a semiconductor factory.

Specifically, as shown in FIG. 1, the inside region of the external bath 20 is communicated to a branch discharge pipe 51a, and the branch discharge pipe 51a is provided with a valve 56a that can open and close. The inside region of the internal bath 11 is communicated to a branch discharge pipe 51b, and the branch discharge pipe 51b is provided with a valve 56b that can open and close. The branch discharge pipes 51a and 51b are communicated to a discharge pipe 54 at a communicating position 81. The discharge pipe 54 is connected in communication to the discharge drain 59 via a common discharge pipe 52.

Therefore, with a pump 53 driven, the valve 56a opened, and the valve 56b closed, a processing solution 25 recovered by the external bath 20 can be drained to the discharge drain 59. On the other hand, with the pump 53 driven, the valve 56b opened, and the valve 56a closed, the deionized water 15 stored in the internal bath 11 can be drained to the discharge drain 59.

The second processing bath 110 is a bath that subjects a plurality of substrates W to a predetermined process, such as a cleaning process and etching, by immersing the substrates W in a processing solution such as stored hydrofluoric acid (HF). As shown in FIG. 1, the second processing bath 110 consists mainly of an internal bath 111 and an external bath 120.

The internal bath 111 is a storage bath to store a processing solution. By immersing a plurality of substrates W in a processing solution 115 stored in the internal bath 111, a plurality of substrates W can be subjected to the same cleaning process at one time.

Disposed in the vicinity of the bottom of the internal bath 111 are two processing solution nozzles 117, through which a processing solution is expelled to the inside of the internal bath 111. Each processing solution nozzle 117 is connected in communication to a hydrofluoric acid source 41 via a corresponding branch pipe 162 and a common piping 40. The common piping 40 is provided with a valve 42 that can open and close.

Consequently, with the valve 42 opened, hydrofluoric acid is supplied from the processing solution nozzles 117 in the direction indicated by the arrow AR3, so that hydrofluoric acid is stored in the internal bath 111.

The external bath 120 is a recovery bath disposed so as to surround an upper end part of the internal bath 111, as shown in FIG. 1. This enables the external bath 120 to recover a processing solution supplied to and overflowing the internal bath 111, as in the case with the external bath 20.

When the processing solution used in a substrate processing in the second processing bath 110 is drained as a solution to be discharged, this solution to be discharged is drained to the discharge drain 59, as in the case with the first processing bath 10. Specifically, as shown in FIG. 1, the inside region of the external bath 120 is communicated to a branch discharge pipe 151a, and the branch discharge pipe 151a is provided with a valve 156a that can open and close. The inside region of the internal bath 111 is communicated to a branch discharge pipe 151b, and the branch discharge pipe 151b is provided with a valve 156b that can open and close. The branch discharge pipes 151a and 151b are communicated to a discharge pipe 154 at a communicating position 181. The discharge pipe 154 is connected in communication to the discharge drain 59 via the common discharge pipe 52.

Therefore, with a pump 153 driven, the valve 156a opened, and the valve 156b closed, a processing solution 125 recovered by the external bath 120 can be drained to the discharge drain 59. On the other hand, with the pump 153 driven, the valve 156b opened, and the valve 156a closed, the processing solution 115 stored in the internal bath 111 can be drained to the discharge drain 59.

The holding mechanism 30 holds and transports a plurality of substrates W between the first processing bath 10 and the second processing bath 110. As shown in FIG. 1, the holding mechanism 30 consists mainly of a lifter 31 and a plurality of holding bars 32 (32a to 32c). The lifter 31 can be moved up and down in the direction indicated by the arrow AR4 (the Z-axis direction), and can also be moved horizontally in the direction indicated by the arrow AR5 (the X-axis direction) by a driving mechanism (not shown).

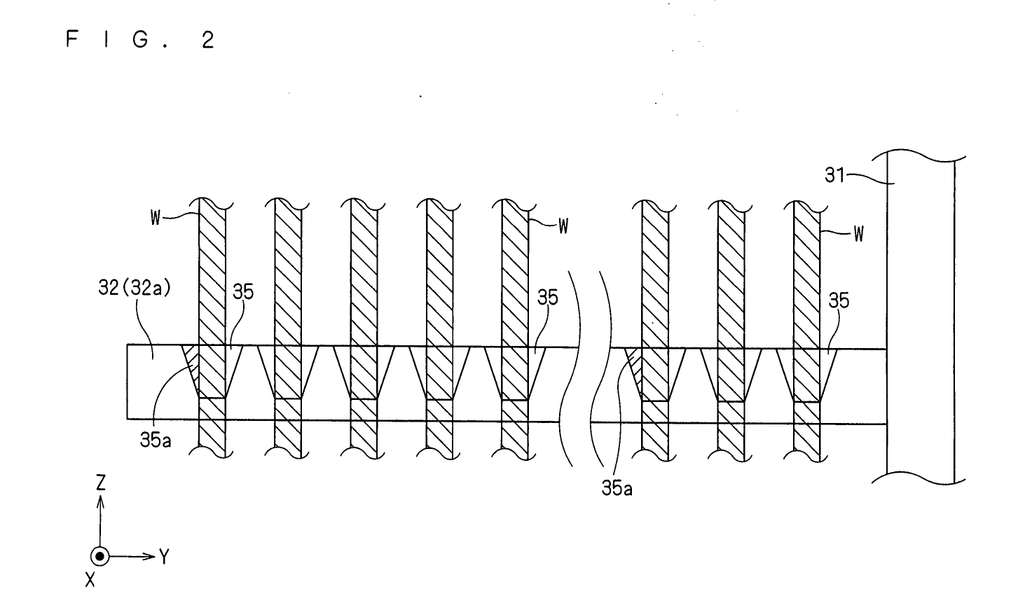

FIG. 2 is a diagram when the holding bar 32a is viewed from the holding bar 32c side. As shown in FIGS. 1 and 2, the plurality of holding bars 32 (32a to 32c) are bar-shaped members, each extending along the Y-axis direction. One end of the respective holding bars 32 (32a to 32c) is attached to the lifter 31.

More specifically, as shown in FIG. 1, the holding bars 32a and 32c are attached to the lifter 31 such that they reach near the corresponding deionized water nozzles 19 when the holding mechanism 30 is moved down to the inside of the internal bath 11. The holding bar 32b is attached to the lifter 31 so as to be substantially the same distance from each of the deionized water nozzles 17.

The three holding bars 32 are provided with a plurality of holding grooves 35 (see FIG. 2), respectively. Each holding groove 35 is a notch, whose cross section when viewed from the X-axis direction (namely from the width direction of the each holding bar 32) is substantially U-shape. The upper part of each holding groove 35 can be opened. With this construction, each substrate W can be held in its stand position when its outer edge is fit in a corresponding holding groove.

Therefore, by controlling the operation situations of the driving mechanism (not shown), the plurality of substrates W held by the plurality of holding bars 32 can be immersed in the deionized water stored in the internal bath 11 and the processing solution stored in the internal bath 111, achieving a predetermined process. By controlling the position in the height direction (the Z-axis direction) of the holding mechanism 30, the holding bars 32a, 32c and the deionized water nozzle 19 can be brought into substantially the same height.

Referring to FIG. 1, a controller 90 includes a memory 91 that stores a program, variables and etc., and a CPU 92 that executes control under the program stored in the memory 91. Hence, the CPU 92 can execute at a predetermined timing the opening and closing control of the valves 42, 47a, 47b, 56a, 56b, 156a, and 156b, and the driving control of the pumps 53, 153, and the lifter 31.

<1.2. Cleaning Procedure of Holding Bars>

In the substrate processing apparatus 1 of the first preferred embodiment, a chemical solution process and a cleaning process of a plurality of substrates W are carried out by the following procedure. That is, (i) the chemical solution process of a plurality of substrates W is carried out by immersing the substrates W in hydrofluoric acid stored in the second processing bath 110, while holding them by the holding mechanism 30. Next, (ii) the plurality of substrates W after being subjected to the chemical solution process are held and transported to the first processing bath 10 by the holding mechanism 30. Subsequently, (iii) a cleaning process of the plurality of substrates W is carried out by immersing them in deionized water stored in the internal bath 11 of the first processing bath 10.

In this procedure, the holding mechanism 30 holds the plurality of substrates W during the chemical solution process, so that the chemical solution 115 stored in the internal bath 111 adheres to the holding grooves 35 of the holding bars 32. In some cases, even after the cleaning process with the deionized water 15 stored in the internal bath 11, a residue 35a of the chemical solution is not completely eliminated from the holding grooves 35 and remains adhered. As a result, the residue 35a in the holding grooves 35 becomes a particle source, causing poor processing of the substrates W.

The influence of the residue 35a can pose serious in the holding grooves 35 of the holding bars 32a and 32c. Specifically, when deionized water is stored in the internal bath 11, a stream of water that can be formed by deionized water expelled from the two deionized water nozzles 17 is strong enough to wash the residue 35 in the holding grooves 35. More specifically, applying a stream of water can eliminate the residue 35a remaining in the holding grooves 35 of the holding bar 32b from the holding grooves 35. Consequently, without adding any hardware to the holding bar 32b, the cleaning process to the holding grooves 35 can be carried out well.

On the contrary, the strength of a stream of water that is expelled from the deionized water nozzles 17 and reaches the holding bars 32a and 32c is weaker than that of the stream of water that reaches the holding bar 32b. Therefore, in some cases, it fails to wash sufficiently the residue 35a.

For this reason, the first preferred embodiment adds the deionized water nozzles 19, which can expel deionized water to the holding bars 32a and 32c, respectively. By the presence of deionized water expelled from the deionized water nozzles 19, a stream of water that reach the holding bars 32a and 32c can be strong enough to wash the residue 35a. It is therefore possible to prevent the residue 35a from remaining adhered to the holding grooves 35, thereby preventing poor processing of the substrates.

Specifically, a cleaning process of the respective holding bars 32 is carried out in the following procedure. Prior to the cleaning process, deionized water is supplied from the deionized water nozzles 17, so that the deionized water is stored in the internal bath 11. That is, the cleaning process of the holding bars 32 is started upon completion of the step of storing deionized water in the internal bath 11.

First, the holding mechanism 30 holding a plurality of substrates W is immersed in the deionized water stored in the internal bath 11. At this time, the holding mechanism 30 is moved down such that the positions in the height direction of the holding bars 32a and 32c are substantially the same as those of the deionized water nozzles 19. The deionized water nozzles 17 keep supplying deionized water, so that deionized water overflows the internal bath 11 toward the external bath 20.

Subsequently, the corresponding deionized water nozzles 19 expel deionized water to the holding bars 32a and 32c. This applies a sufficiently strong steam to the holding bars 32a and 32c, enabling the residue 35a adhered to the holding grooves 35 of the holding bars 32a and 32c to be well eliminated and cleaned.

During the time the deionized water nozzles 19 expel deionized water, the two deionized water nozzles 17 keep supplying deionized water. This enables the holding grooves 35 of the holding bar 32b to be cleaned well by a stream of water that can be formed by the deionized water supplied from these deionized water nozzles 17. Likewise, the plurality of substrates W held by the holding mechanism 30 can be cleaned.

After an elapse of a predetermined time, the deionized water nozzles 19 stops expelling deionized water. Even after the deionized water nozzles 19 stops expelling deionized water, the deionized water nozzles 17 keep supplying deionized water. Therefore, the cleaning process of the substrates W is subsequently carried out.

<1.3. Advantages of Substrate Processing Apparatus of First Preferred Embodiment>

Thus, the substrate processing apparatus 1 of the first preferred embodiment is capable of supplying deionized water expelled from the deionized water nozzles 19 to the holding grooves 35 of the holding bars 32a and 32c. It is therefore possible to wash well the residue 35 present in the holding grooves 35, which cannot be washed sufficiently only by the deionized water supplied from the deionized water nozzles 17. This prevents particle generation thereby to prevent poor processing of the substrates.

### 2. Second Preferred Embodiment

A second preferred embodiment of the present invention will next be described. A substrate processing apparatus 200 of the second preferred embodiment is similar to the substrate processing apparatus 100 of the first preferred embodiment, except that a chemical solution process and a cleaning process are carried out in one processing bath 210. Therefore, the following is pointed to this difference.

In the following description, the same reference numerals have been used to denote components similar to those in the substrate processing apparatus 1 of the first preferred embodiment. Therefore, the descriptions of these similar components have been left out of the following.

<2.1. Construction of Substrate Processing Apparatus>

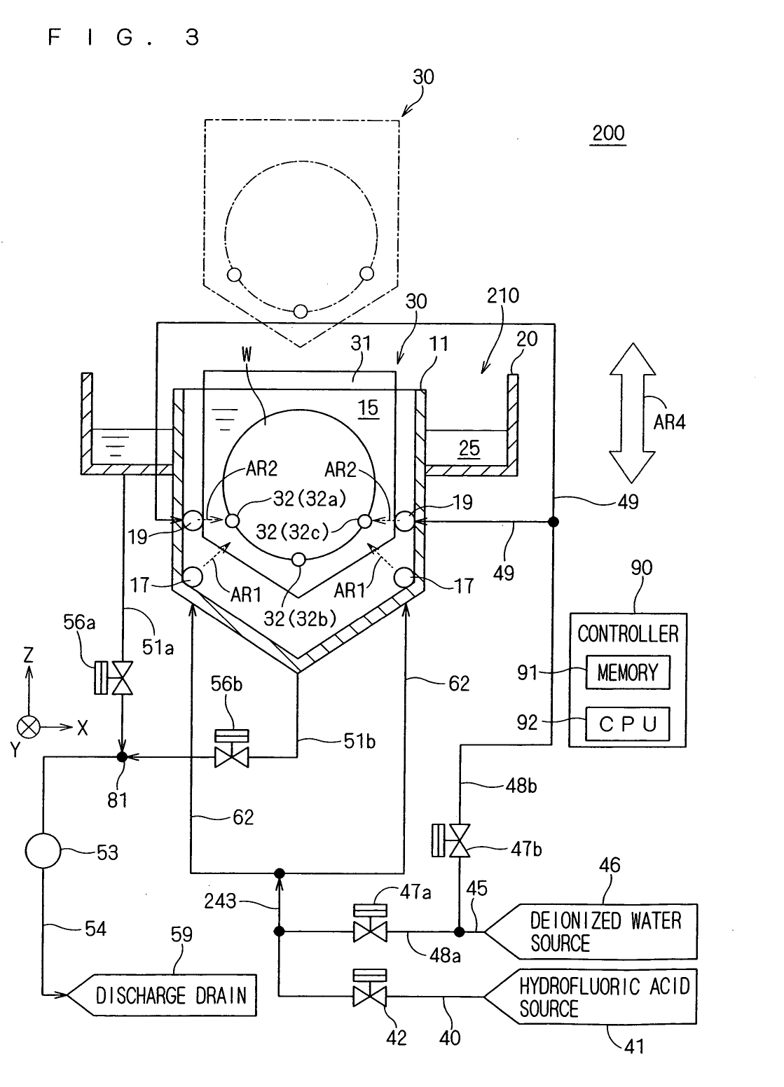

FIG. 3 is a diagram for the sake of explaining the overall construction of the substrate processing apparatus 200 according to the second preferred embodiment of the present invention. Like the substrate processing apparatus 1, the substrate processing apparatus 200 is a so-called “batch processing” apparatus. As shown in FIG. 3, the substrate processing apparatus 200 consists mainly of a processing bath 210 and a holding mechanism 30.

The processing bath 210 is a multifunction bath that can store a chemical solution or deionized water, and perform a variety of chemical solution processes and cleaning process within a single bath. As shown in FIG. 3, the processing bath 210 consists mainly of an internal bath 11 and an external bath 20. The internal bath 11 is a storage bath to store a processing solution, deionized water, or the like. By immersing a plurality of substrates W in a processing solution 15 stored in the internal bath 11, the plurality of substrates W can be subjected to a predetermined substrate processing.

Disposed in the vicinity of the bottom of the internal bath 11 are two processing solution nozzles 17, through which a processing solution is expelled to the inside of the internal bath 11. Each processing solution nozzle 17 is connected in communication to a deionized water source 46 via corresponding branch pipe 62, piping 243 and piping 48a, and a common piping 45. Each processing solution nozzle 17 is also connected in communication to a hydrofluoric acid source 41 via the corresponding branch pipe 62 and piping 243, and a common piping 40. The piping 48a and the common piping 40 are provided with valves 47a and 42, respectively, which can open and close.

Two deionized water nozzles 19 are disposed on the inside of the internal bath 11, above the processing solution nozzles 17. Each deionized water nozzle 19 is connected in communication to the deionized water source 46 via corresponding branch pipe 49 and piping 48b, and the common piping 45. The piping 48b is provided with a valve 47b that can open and close.

Consequently, with both of the valves 47a and 47b opened and the valve 42 closed, deionized water is expelled from the processing solution nozzles 17 in the direction indicated by the arrow AR1, and from the deionized nozzles 19 in the direction indicated by the arrow AR2. With the valve 47a opened and the valves 42 and 47b closed, deionized water is supplied from the processing solution nozzles 17 to the inside of the internal bath 11. With the valve 47b opened and the valves 42 and 47a closed, deionized water is supplied from the deionized water nozzles 19 to the inside of the internal bath 11. With the valve 42 opened and the valves 47a and 47b closed, hydrofluoric acid as a chemical solution is supplied from the processing solution nozzles 17 to the inside of the internal bath 11.

Thus, in the internal bath 11 of the processing bath 210 a chemical solution process and a cleaning process can be carried out by using a chemical solution and deionized water supplied from the processing solution nozzles 17 and the deionized water nozzles 19, respectively.

The external bath 20 is a recovery bath disposed so as to surround an upper end part of the internal bath 11, as shown in FIG. 3. This enables the external bath 20 to recover a processing solution supplied to and overflowing the internal bath 11.

When the processing solution used in a substrate processing in the processing bath 210 is drained as a solution to be discharged, this solution to be discharged is drained to a discharge drain 59. Specifically, as shown in FIG. 3, the inside region of the external bath 20 is communicated to a branch discharge pipe 51a, and the branch discharge pipe 51a is provided with a valve 56a that can open and close. The inside region of the internal bath 11 is communicated to a branch discharge pipe 51b, and the branch discharge pipe 51b is provided with a valve 56b that can open and close. The branch discharge pipes 51a and 51b are communicated to a discharge pipe 54 at a communicating position 81. The discharge pipe 54 is connected in communication to the discharge drain 59.

Therefore, with a pump 53 driven, the valve 56a opened, and the valve 56b closed, a processing solution 25 recovered by the external bath 20 can be drained to the discharge drain 59. On the other hand, with the pump 53 driven, the valve 56b opened, and the valve 56a closed, the processing solution 15 stored in the internal bath 11 can be drained to the discharge drain 59.

The holding mechanism 30 holds and transports a plurality of substrates W. As shown in FIG. 3, the holding mechanism 30 consists mainly of a lifter 31 and a plurality of holding bars 32 (32a to 32c). The lifter 31 can be moved up and down at least in the direction indicated by the arrow AR4 (the Z-axis direction) by a driving mechanism (not shown).

Therefore, by controlling the operation situations of the driving mechanism (not shown), the plurality of substrates W held by the plurality of holding bars 32 can be immersed in the processing solution stored in the internal bath 11, achieving a predetermined process. By controlling the position in the height direction (the Z-axis direction) of the holding mechanism 30, the holding bars 32a, 32c and the deionized water nozzle 19 can be brought into substantially the same height.

<2.2. Cleaning Procedure of Holding Bars>

In the substrate processing apparatus 200 of the second preferred embodiment, a chemical solution process and a cleaning process of a plurality of substrates W are carried out in the following procedure. That is, (i) the chemical solution process of a plurality of substrates W is carried out by immersing the substrates W in hydrofluoric acid stored in the processing bath 210, while holding them by the holding mechanism 30. Next, (ii) hydrofluoric acid is discharged from the internal bath 1, and deionized water is stored in the internal bath 11. Subsequently, (iii) a cleaning process of the plurality of substrates W is carried out by immersing them in deionized water stored in the internal bath 11.

In this procedure, the holding mechanism 30 holds the plurality of substrates W during the chemical solution process, so that the chemical solution (hydrofluoric acid) used in the chemical solution process adheres to the holding grooves 35 of the holding bars 32. In some cases, even after the cleaning process is carried out with the deionized water that has been stored in the internal bath 11 after discharging the used solution, a residue 35a of the chemical solution is not completely eliminated from the holding grooves 35 and remains adhered. As a result, the residue 35a in the holding grooves 35 becomes a particle source, causing poor processing of the substrates W.

For this reason, like the first preferred embodiment, the deionized water nozzles 19 expel deionized water to the holding bars 32a and 32c in the second preferred embodiment. Thereby, a stream of water that reaches the holding bars 32a and 32c can be strong enough to wash the residue 35a. It is therefore possible to prevent the residue 35a from remaining adhered to the holding grooves 35, thereby preventing poor processing of the substrates.

Specifically, a cleaning process of the respective holding bars 32 is carried out in the following procedure. Prior to the cleaning process, the hydrofluoric acid used for the chemical solution process is discharged from the internal bath 11, and deionized water is then stored. That is, the cleaning process of the holding bars 32 is started upon completion of the step of storing deionized water in the internal bath 11.

On completion of the step of storing deionized water into the internal bath 11, the holding mechanism 30 moves such that the positions in the height direction of the holding bars 32a and 32c are substantially the same as those of the deionized water nozzles 19. At this time, the processing solution nozzles 17 keep supplying deionized water, so that deionized water overflows the internal bath 11 toward the external bath 20.

Subsequently, the corresponding deionized water nozzles 19 expel deionized water to the holding bars 32a and 32c. This applies a sufficiently strong steam of water to the holding bars 32a and 32c, so that the residue 35a adhered to the holding grooves 35 of the holding bars 32a and 32c can be cleaned well.

During the time the deionized water nozzles 19 expel deionized water, the two processing solution nozzles 17 keep supplying deionized water. This enables the holding grooves 35 of the holding bar 32b to be cleaned well by a stream of water that can be formed by the deionized water supplied from these processing solution nozzles 17. Likewise, the plurality of substrates W held by the holding mechanism 30 can be cleaned.

After an elapse of a predetermined time, the deionized water nozzles 19 stops expelling deionized water. Even after the deionized water nozzles 19 stops expelling deionized water, the deionized water nozzles 17 keep supplying deionized water. Therefore, the cleaning process of the substrates W is subsequently carried out.

<2.3. Advantages of Substrate Processing Apparatus of Second Preferred Embodiment>

Thus, the substrate processing apparatus 200 of the second preferred embodiment is capable of supplying deionized water expelled from the deionized water nozzles 19 to the holding grooves 35 of the holding bars 32a and 32c. This prevents particle generation thereby to prevent poor processing of the substrates.

### 3. Third Preferred Embodiment

A third preferred embodiment of the present invention will next be described. A substrate processing apparatus 300 of the third preferred embodiment is similar to the first preferred embodiment, except for (i) addition of a fixed holding part 314 to an internal bath 11; and (ii) a different procedure of cleaning holding bars 32. Therefore, the following is pointed to these differences.

In the following description, the same reference numerals have been used to denote components similar to those in the substrate processing apparatus 1 of the first preferred embodiment. Since these similar components have been described in the first preferred embodiment, the descriptions thereof have been left out of the following.

<3.1. Construction of Substrate Processing Apparatus>

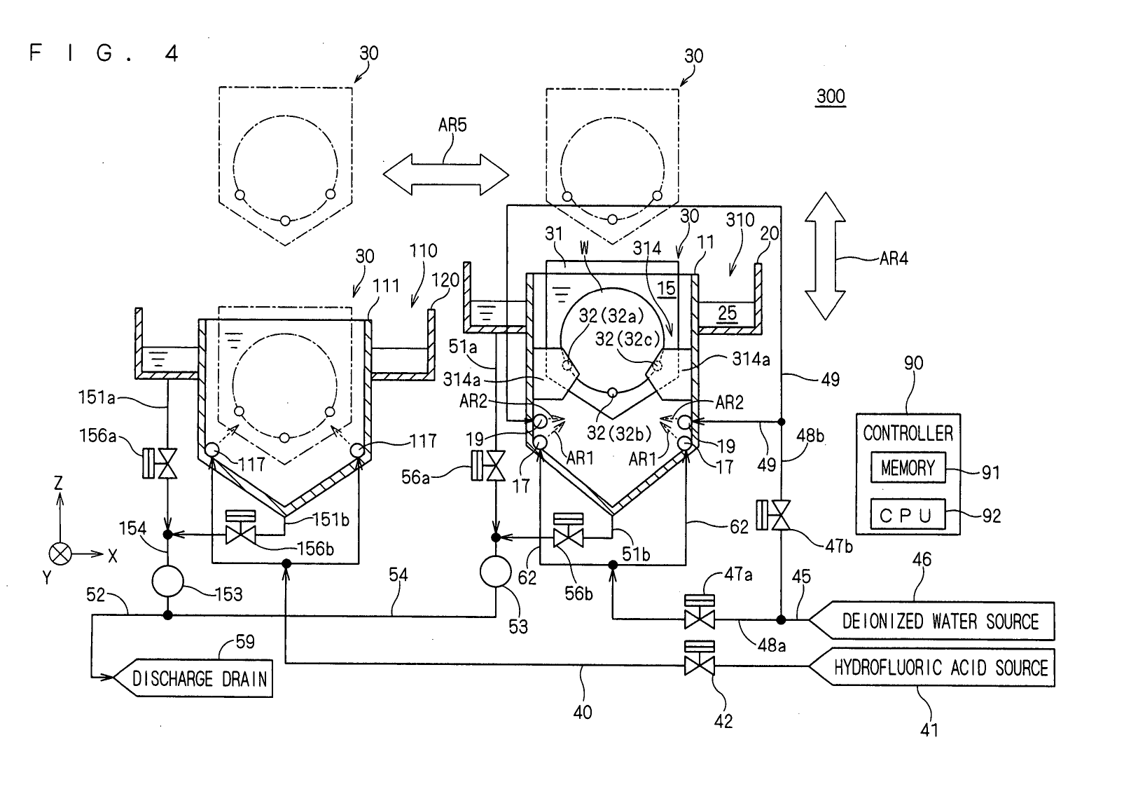

FIG. 4 is a diagram for the sake of explaining the overall construction of a substrate processing apparatus 300 according to the third preferred embodiment of the present invention. Like the substrate processing apparatus 1, the substrate processing apparatus 300 is a so-called “batch processing” apparatus. As shown in FIG. 4, the substrate processing apparatus 300 consists mainly of a first processing bath 310, a second processing bath 110, and a holding mechanism 30.

The first processing bath 310 is similar to the first processing bath 10 of the first preferred embodiment, except for the addition of the fixed holding part 314. As shown in FIG. 4, the fixed holding part 314 has two holding members 314a that are fixed to the inside of the first processing bath 310, above deionized water nozzles 17 and deionized water nozzles 19. Each of the holding members 314a is provided with a plurality of holding grooves (not shown). Each substrate W can be held in its stand position when its outer edge portion is fit in a corresponding holding groove.

<3.2. Cleaning Procedure of Holding Bars>

The substrate processing apparatus 300 of the third preferred embodiment performs the same substrate processing as the substrate processing apparatus 1. That is, (i) a chemical solution process is carried out in the second processing bath 110. Next, (ii) upon completion of the chemical solution process, a plurality of substrates W are transported from the second processing bath 110 to the first processing bath 310. Subsequently, (iii) a cleaning process with deionized water is carried out in the first processing bath 310. Thereby, like the substrate processing apparatus 1 of the first preferred embodiment, a residue 35a in holding grooves 35 becomes a particle source, causing poor processing of the substrates W.

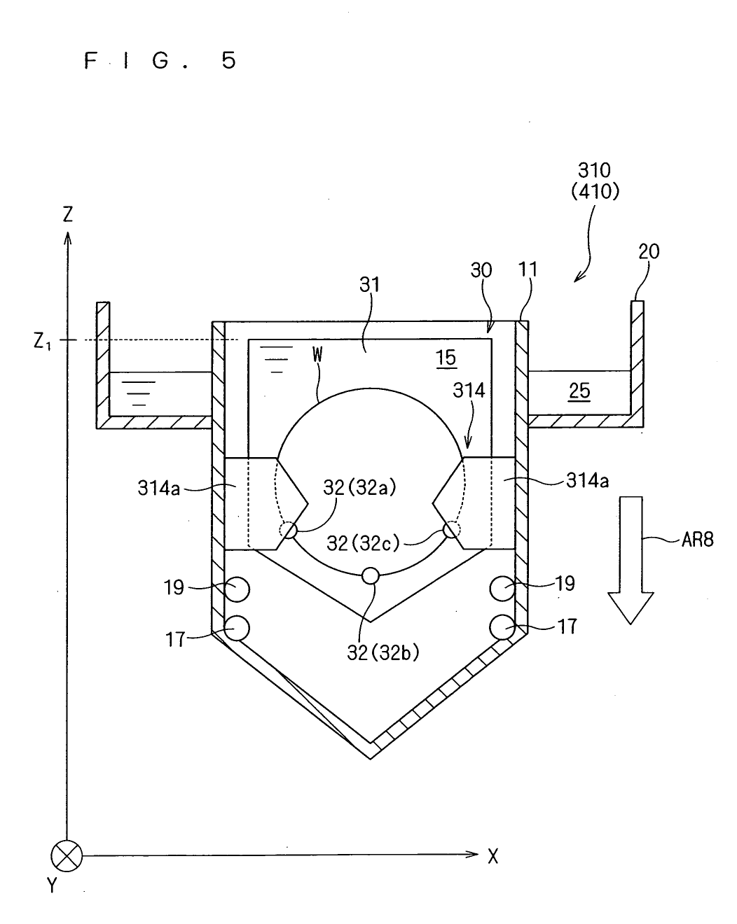

For this reason, in the third preferred embodiment the deionized water expelled from the deionized water nozzles 19 is used to perform a cleaning process of the holding grooves 35, as in the first preferred embodiment. FIGS. 5 to 7 are diagrams for the sake of explaining the procedure of cleaning the holding bars 32. The respective holding bars 32 are cleaned in the following procedure. Prior to the cleaning process, deionized water is supplied from the deionized water nozzles 17, so that the deionized water is stored in the internal bath 11.

First, a plurality of substrates W transported from the second processing bath 110 are moved down by the holding mechanism 30 to the inside of the processing bath 310 in the direction indicated by the arrow AR8. At this time, when a position Z in the height direction (the Z-axis direction) of the holding mechanism 30 is Z1, the outer edge portions of the substrates W fit in the holding grooves 35 of the holding bars 32 and the holding grooves of the holding members 314a, respectively (see FIG. 5).

When the holding mechanism 30 is further moved down, the two holding members 314a hold the substrates W, respectively, and the holding bars 32 depart from the corresponding substrates W. That is, the holding bars 32 are moved down without holding the substrates W.

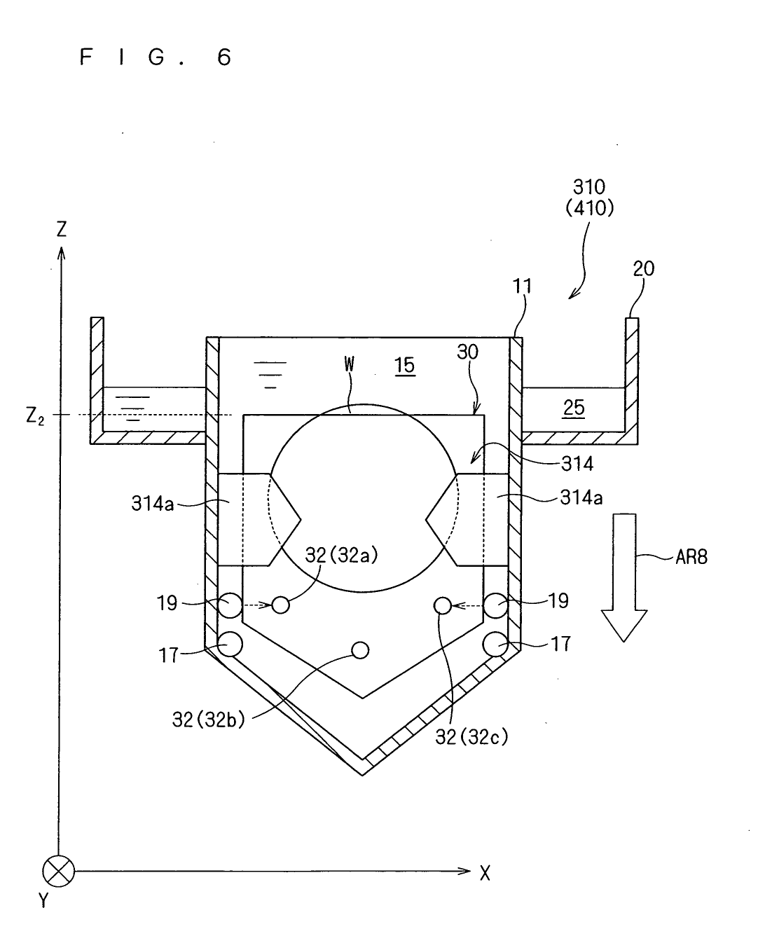

When the holding mechanism 30 reaches a position Z2 (see FIG. 6), at which the position in the height direction of the holding mechanism 30 is substantially the same as those of the holding bars 32a and 32c and the deionized water nozzles 19, a down movement of the holding mechanism 30 is stopped. During the time the holding mechanism 30 moves down, the deionized water nozzles 17 keep supplying deionized water, so that deionized water overflows the internal bath 11 toward the external bath 20.

Subsequently, the corresponding deionized water nozzles 19 expel deionized water to the holding bars 32a and 32c. Specifically, the deionized water from the deionized water nozzles 19 can be applied to the holding grooves 35 of the holding bars 32a and 32c, into which no substrate W fit. Thereby, the residue 35a adhered to the holding grooves 35 can be washed better. This further prevents the residue 35a from remaining in the holding grooves 35 of the holding bars 32a and 32c, thus enhancing prevention of poor processing of the substrates.

During the time the deionized water nozzles 19 expel deionized water, the two deionized water nozzles 17 keep supplying deionized water. This enables the holding grooves 35 of the holding bar 32b to be cleaned well by a stream of water that can be formed by the deionized water supplied from these deionized water nozzles 17. The plurality of substrates W held by the fixed holding member 314 are cleaned with a stream of water from the deionized water nozzles 17. After an elapse of a predetermined time, the deionized water nozzles 19 stops expelling deionized water.

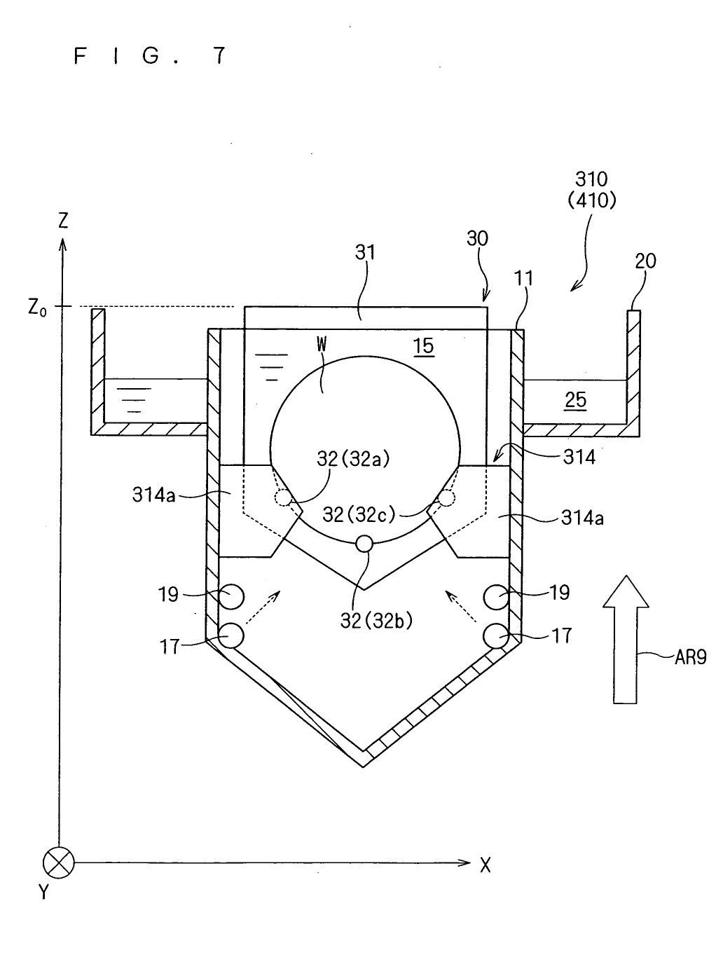

On completion of the cleaning process of the holding bars 32, the holding-mechanism 30 is moved up in the direction indicted by the arrow AR9, so that the holding mechanism 30 shifts to a position Z0 (see FIG. 7). By this up movement, the plurality of substrates W are transferred from the fixed holding part 314 to the holding mechanism 30. With the substrates W held by the holding mechanism 30, they are subjected to a cleaning process by a stream of water expelled from the deionized water nozzles 17.

<3.3. Advantages of Substrate Processing Apparatus of Third Preferred Embodiment>

Thus, the substrate processing apparatus 300 of the third preferred embodiment is capable of washing the residue 35a adhered to the holding grooves 35, while allowing the substrates W to depart from the holding bars 32a to 32c. This enhances prevention of particle generation thereby to prevent poor processing of the substrates.

### 4. Fourth Preferred Embodiment

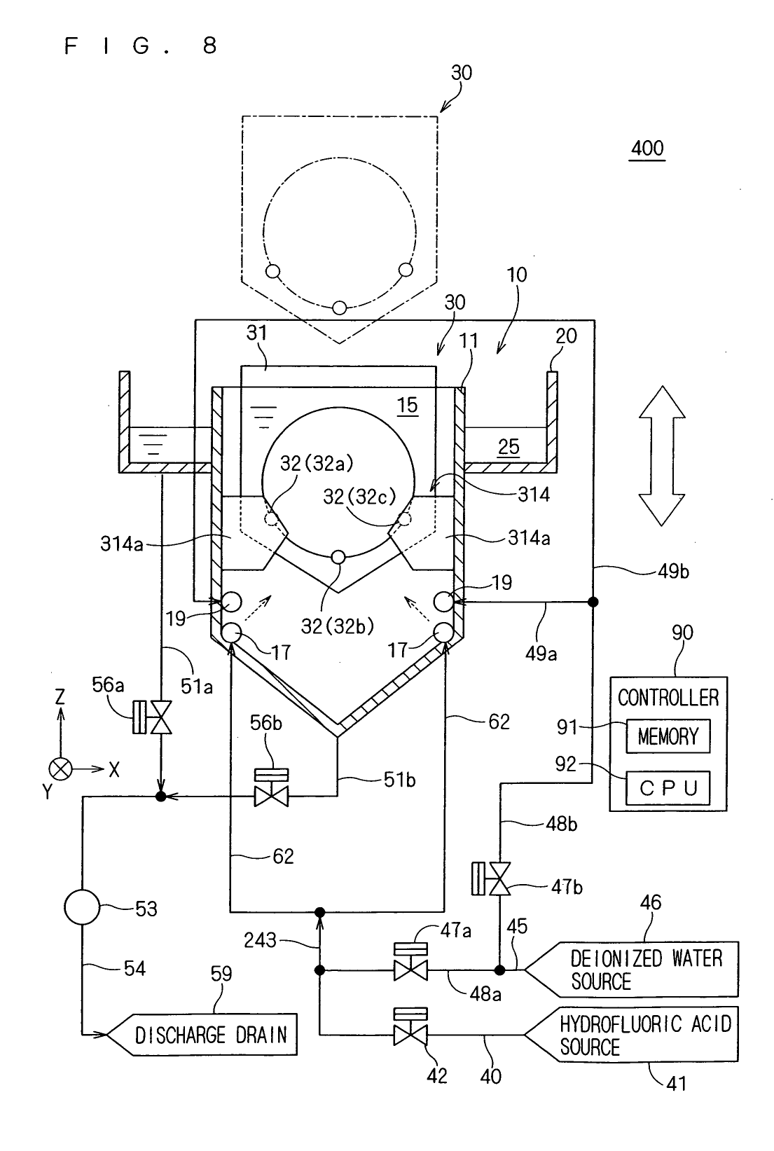

A fourth preferred embodiment of the present invention will next be described. FIG. 8 is a diagram for the sake of explaining the entire construction of a substrate processing apparatus 400 in the fourth preferred embodiment. As shown in FIG. 8, the substrate processing apparatus 400 is similar to the substrate processing apparatus 200 of the second preferred embodiment, except that: (i) a fixed holding part 314 as described in the third preferred embodiment is disposed in an internal bath 11 of a processing bath 410; and (ii) the procedure of cleaning holding bars 32 is different from that in the third preferred embodiment.

Like the third preferred embodiment, the substrate processing apparatus 400 of the fourth preferred embodiment is capable of washing the residue 35a adhered to the holding grooves 35, while allowing the substrates W to depart from the holding bars 32a to 32c. This enhances prevention of particle generation thereby to prevent poor processing of the substrates.

### 5. Fifth Preferred Embodiment

A fifth preferred embodiment of the present invention will next be described. A substrate processing apparatus of the fifth preferred embodiment has the same hardware configuration as the third preferred embodiment, except for the procedure of cleaning the holding bars 32. Therefore, the following is pointed to this difference.

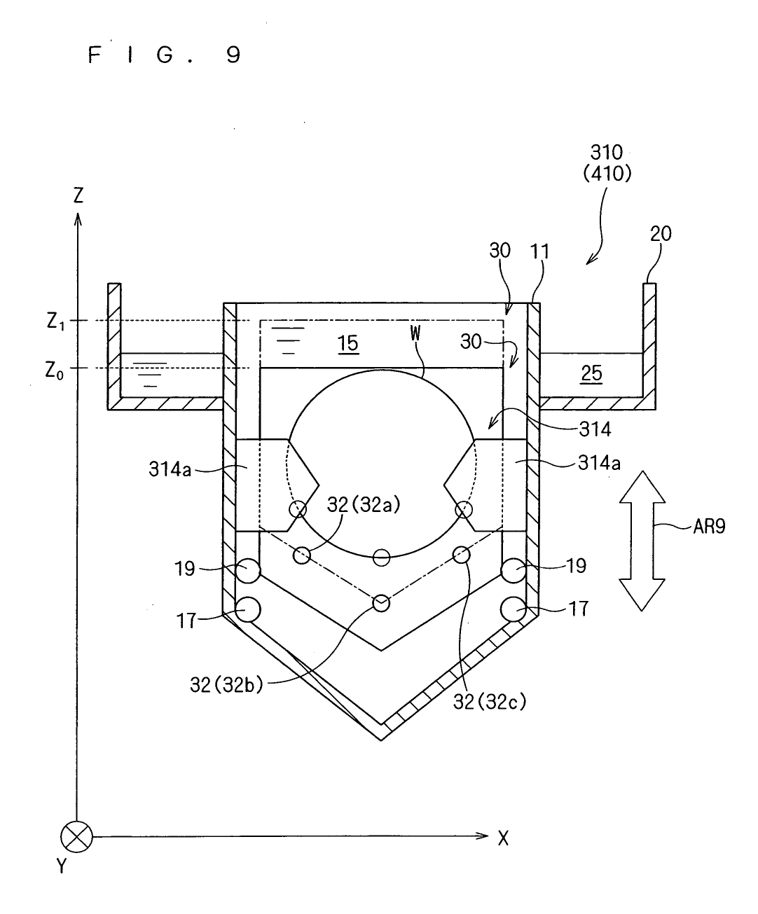

FIG. 9 is a diagram for the sake of explaining a procedure of cleaning the holding bars 32 in the fifth preferred embodiment. Specifically, the cleaning process of the holding bars 32 is carried out by allowing a holding mechanism 30 to move up and down between a position Z₁, at which substrates W fit in holding grooves 35 of the holding bars 32 and holding grooves of a holding member 314a, respectively (a position indicated by dash line in FIG. 9), and a position Z₀, at which the substrates W departs from the holding grooves 35 of the holding bars 32 (a position indicated by solid line in FIG. 9). In other words, the holding mechanism 30 slides between a position Z₁ and a position Z₀ in the height direction. Thereby, a stream of water formed by an up-and-down movement of the holding mechanism 30 can be applied to the holding grooves 35, into which no substrate W fit. It is therefore possible to wash well the residue 35a adhered to the holding grooves 35 of the holding bars 32 thereby to prevent poor processing of the substrates due to particles.

### 6. Sixth Preferred Embodiment

A sixth preferred embodiment of the present invention will next be described. A substrate processing apparatus of the sixth preferred embodiment has the same hardware configuration as the fourth preferred embodiment, except that the cleaning process of holding bars 32 is carried out in the same procedure as the fifth preferred embodiment.

Like the fifth preferred embodiment, the sixth preferred embodiment enables a holding mechanism 30 to slide between a position Z₁ and a position Z₀. Thereby, a stream of water formed by an up-and-down movement of the holding mechanism 30 can be applied to the holding grooves 35, into which no substrate W fit. It is therefore possible to wash well a residue 35a adhered to the holding grooves 35 of the holding bars 32 thereby to prevent poor processing of the substrates due to particles.

### 7. Seventh Preferred Embodiment

A seventh preferred embodiment of the present invention will next be described. A substrate processing apparatus 500 of the seventh preferred embodiment is similar to the substrate processing apparatus 300 of the third preferred embodiment, except for: (i) a difference in position where deionized water nozzles 519 are attached to an internal bath 11; and (ii) a different procedure of cleaning holding bars 32. Therefore, the following is pointed to these differences.

In the following description, the same reference numerals have been used to denote components similar to those in the substrate processing apparatus 300 of the third preferred embodiment. Since these similar components have been described in the third preferred embodiment, the descriptions thereof have been left out of the following.

<7.1. Construction of Substrate Processing Apparatus>

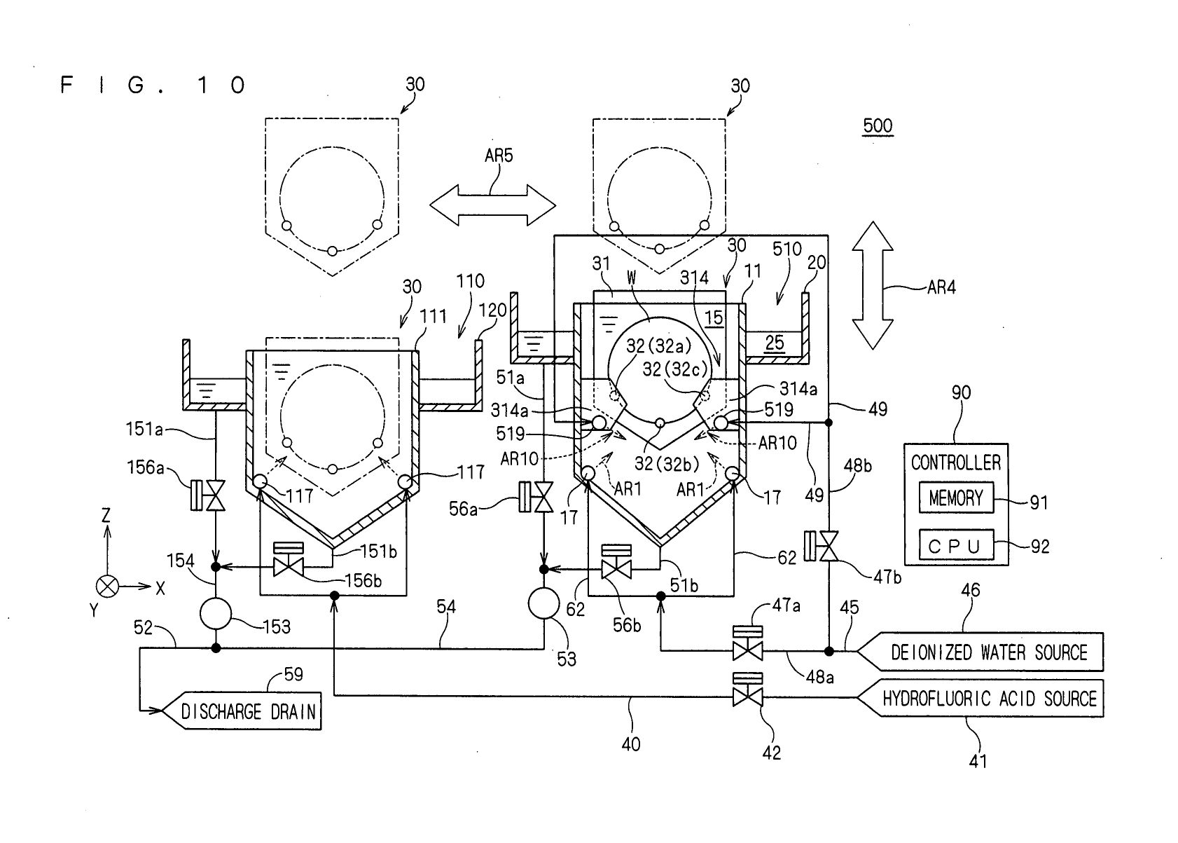

FIG. 10 is a diagram for the sake of explaining the overall construction of a substrate processing apparatus 500 according to the seventh preferred embodiment of the present invention. Like the substrate processing apparatus 300, the substrate processing apparatus 500 is a batch processing apparatus. As shown in FIG. 10, the substrate processing apparatus 500 consists mainly of a first processing bath 510, a second processing bath 110, and a holding mechanism 30.

A fixed holding part 314 is disposed in an internal bath 11 of the first processing bath 510. The fixed holding part 314 has two holding members 314a, each of which is provided with a corresponding deionized water nozzle 519.

Referring to FIG. 10, the two deionized water nozzles 519 are connected in communication to a deionized water source 46 via corresponding branch pipe 49 and piping 48b, and a common piping 45. The piping 48b is provided with a valve 47b that can open and close.

Consequently, with the valve 47a opened and the valve 47b closed, deionized water is expelled from deionized water nozzles 17 in the direction indicated by the arrow AR1 (obliquely above). With the valve 47b opened and the valve 47a closed, deionized water is expelled from the deionized water nozzles 519 in the direction indicated by the arrow AR 10 (obliquely below). With both of the valves 47a and 47b opened, deionized water is expelled from the nozzles 17 and 519.

<7.2. Cleaning Procedure of Holding Bars>

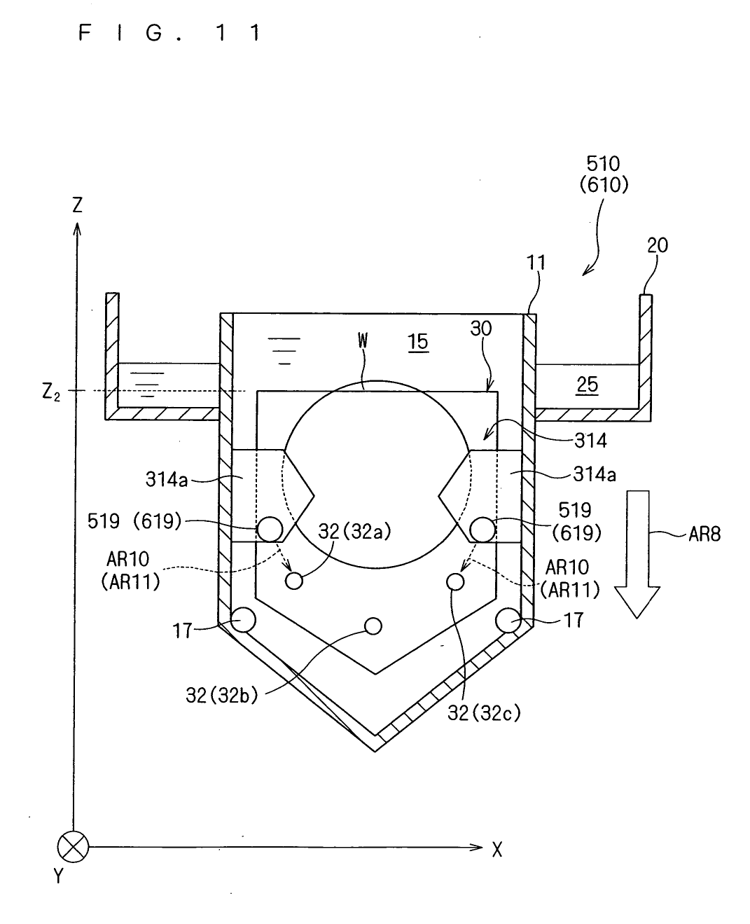

FIG. 11 is a diagram for the sake of explaining a cleaning procedure of holding bars 32. The following is the procedure of cleaning the holding bars 32 in the case where a chemical solution process is carried out in the second processing bar 110, and a residue 35a is adhered to holding grooves 35 of the holding bars 32. Prior to the cleaning process, deionized water is supplied from the deionized water nozzles 17, so that the deionized water is stored in the internal bath 11.

In the cleaning procedure of the seventh preferred embodiment, a plurality of substrates W transported from the second processing bath 110 are moved down into the first processing bath 510 by the holding mechanism 30. Thereby, the two holding members 314a hold the substrates W transferred from the holding bars 32 of the holding mechanism 30, and the holding mechanism 30 is further moved down with no substrates W held by the holding grooved 35 of the holding bars 32 (32a to 32c). When the holding bars 32a and 32c reach beneath their respective corresponding deionized water nozzles 519, a down movement of the holding mechanism 30 is stopped (see FIG. 11). During the time the holding mechanism 30 moves down, the deionized water nozzles 17 keep supplying deionized water, so that deionized water overflows the internal bath 11 toward the external bath 20.

Next, with a plurality of substrates W held by the two holding members 314a, the deionized water nozzles 519 expel deionized water to holding grooves 35 of the corresponding holding bars 32a and 32c, respectively (namely from the upper side of the holding grooves 35 that hold no substrate W, to the holding grooves 35).

Thereby, deionized water can be supplied efficiently from an opening of the upper part of each holding groove 35 to the vicinity of the inner wall of the holding groove 35, achieving better elimination of a chemical solution remaining in the holding groove 35. This can suppress particle generation resulting from the chemical solution, enhancing prevention of poor processing of the substrates W.

During the time the deionized water nozzles 519 expel deionized water, the two deionized water nozzles 17 keep supplying deionized water. This enables the holding grooves 35 of the holding bar 32b to be cleaned well by a stream of water that can be formed by the deionized water from these deionized water nozzles 17. Likewise, the plurality of substrates W held by the holding mechanism 30 can be cleaned with a stream of water from the deionized water nozzles 17. After an elapse of a predetermined time, the deionized water nozzles 519 stops expelling deionized water, and the cleaning process of the holding bars 32 is completed.

On completion of the cleaning process of the holding bars 32, the holding mechanism 30 is moved up, and the plurality of substrates W are transferred from the fixed holding part 314 to the holding mechanism 30. With the substrates W held by the holding mechanism 30, they are subjected to a cleaning process by using a stream of water expelled from the deionized water nozzles 17.

<7.3. Advantages of Substrate Processing Apparatus of Seventh Preferred Embodiment>

Thus, the substrate processing apparatus 500 of the seventh preferred embodiment allows the substrates W to depart from the holding bars 32a to 32c, and enables the deionized water nozzles 519 to supply deionized water from the upper side of the holding grooves 35 to the holding grooves 35 of the holding bars 32a and 32c. This permits better washing of the residue 35a adhered to the holding grooves 35, enhancing prevention of poor processing of the substrates W.

### 8. Eighth Preferred Embodiment

An eighth preferred embodiment of the present invention will next be described. A substrate processing apparatus 600 of the eighth preferred embodiment is similar to the substrate processing apparatus 400 of the fourth preferred embodiment, except that: (i) there is a difference in position where deionized water nozzles 619 are attached to an internal bath 11; and (ii) holding bars 32 are cleaned in the same procedure as in the seventh preferred embodiment. Therefore, the following is pointed to these differences.

In the following description, the same reference numerals have been used to denote components similar to those in the substrate processing apparatus 400 of the fourth preferred embodiment. Since these similar components have been described in the fourth preferred embodiment, the descriptions thereof have been left out of the following.

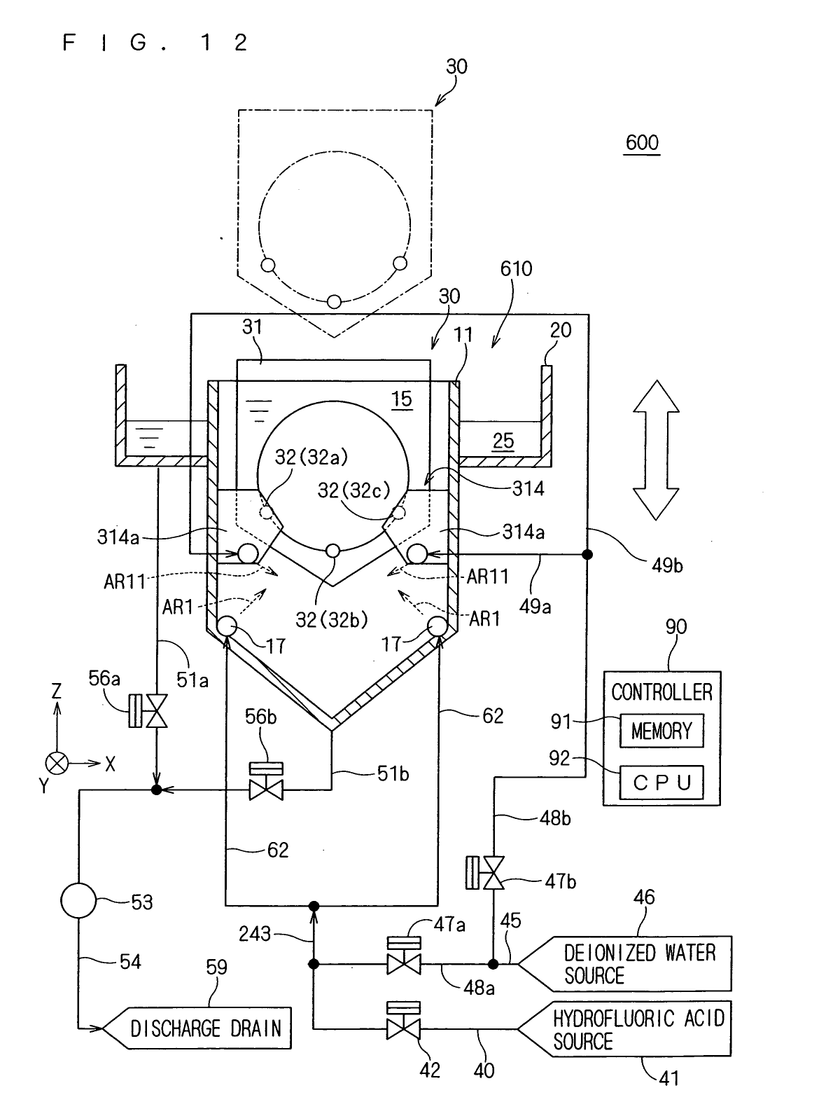

FIG. 12 is a diagram for the sake of explaining the overall construction of the substrate processing apparatus 600 according to the eighth preferred embodiment of the present invention. Like the substrate processing apparatus 400, the substrate processing apparatus 600 is a batch processing apparatus. As shown in FIG. 12, the substrate processing apparatus 600 consists mainly of a processing bath 610 and a holding mechanism 30.

A fixed holding part 314 is disposed in an internal bath 11 of the processing bath 610. The fixed holding part 314 has two holding members 314a, each of which is provided with a corresponding deionized water nozzle 619.

Referring to FIG. 12, the two deionized water nozzles 619 are connected in communication to a deionized water source 46 via corresponding branch pipe 49(49a, 49b) and piping 48b, and a common piping 45. The piping 48b is provided with a valve 47b that can open and close.

Consequently, with the valve 47a opened and the valve 47b closed, a processing solution is expelled from processing solution nozzles 17 in the direction indicated by the arrow AR1 (obliquely above). With the valve 47b opened and the valve 47a closed, deionized water is expelled from the deionized water nozzles 619 in the direction indicated by the arrow AR11 (obliquely below). With both of the valves 47a and 47b opened, deionized water is expelled from the nozzles 17 and 619.

By employing such a hardware construction, the substrate processing apparatus 600 of the eighth preferred embodiment can expel, with a plurality of substrates W held by the two holding members 314a, deionized water from the deionized water nozzles 619 to the corresponding holding grooves 35 of holding bars 32a and 32c, respectively (namely from the upper side of the holding grooves 35 that hold no substrate W, to the holding grooves 35).

Thereby, like the substrate processing apparatus 500 of the seventh preferred embodiment, the substrate processing apparatus 600 of the eighth preferred embodiment can supply efficiently deionized water from an opening of the upper side of each holding groove 35 to the vicinity of the inner wall of the holding groove 35, achieving better elimination of the chemical solution remaining in the holding grooves 35. This prevents particle generation resulting from a chemical solution, enhancing prevention of poor processing of the substrates W.

### 9. Modifications

While the invention has been shown in the foregoing preferred embodiments, it is not so limited but is susceptible of various changes and modification as follows.

(I) Although the first, third, fifth, and seventh preferred embodiments have discussed the first processing bath 10 (310, 510) and the second processing bath 110 as one that stores only deionized water, either one or both of the first processing bath 10 (310, 510) and the second processing bath 110 may be a multifunction processing bath capable of storing a plurality of types of processing solutions. That is, the first processing bath 10 (310, 510) may store at least deionized water, and the second processing bath 110 may store at least a chemical solution.

(II) Although in the second processing bath 110 of the first, third, fifth, and seventh preferred embodiments, and in the second processing baths 210, 410, and 610 of the second, fourth, sixth, and eighth preferred embodiments, a processing solution overflowing the internal bath 111, 11 has been discussed as one that is drained to the discharge drain 59, there may be employed such a hardware construction as to allow a processing solution (particularly, a chemical solution) overflowing the external bath 120, 20 to be recycled to the internal bath 111, 11 (namely as to enable circulating process of a processing solution).

(III) Although the first, third, fifth, and seventh preferred embodiments have discussed the case of using two processing baths, and the second, fourth, sixth, and eighth preferred embodiments have discussed the case of using one processing bath, the former may employ three or more processing baths, and the latter may employ two or more processing baths.

(IV) Although in the first to fourth, seventh, and eighth preferred embodiments have discussed that the process of cleaning the holding bars 32a and 32c with deionized water expelled from the deionized water nozzle 19, 519, 619 is carried out after deionized water is stored in the internal bath 11, there are the following alternatives. For example, the cleaning of the holding bars 32a and 32c may be completed at a point of time before the process of storing deionized water in the internal bath 11 is started. Alternatively, the holding bars 32a and 32c may be cleaned by allowing the deionized water nozzles 19 to expel deionized water, while storing deionized water from the deionized water nozzles 17 into the internal bath 11 (namely when deionized water is stored in the internal bath 11).

(V) Although in the second and fourth preferred embodiments the process of shifting the holding mechanism 30 such that the position in the height direction of the holding bars 32a and 32c is substantially the same as those of the deionized water nozzles 19 is carried out after the process of storing deionized water in the internal bath 11 is completed, there are the following alternatives. For example, this may be before deionized water for storage is supplied to the internal bath 11, or when deionized water for storage is supplied. Likewise, in the eighth preferred embodiment, the process of shifting the holding bars 32a and 32c to beneath the corresponding deionized water nozzles 519 may be before deionized water for storage is supplied to the internal bath 11, or when deionized water for storage is supplied, without limiting to after the process of storing deionized water in the internal bath 11 is completed.

(VI) Although in the fifth and sixth preferred embodiments the cleaning of the holding grooves 35 of the holding bars 32 is carried out by allowing the holding mechanism 30 to move up with a plurality of substrates W held by the fixed holding part 314, there is the following alternative. That is, the residue 35a remaining in the holding grooves 35 of the holding bars 32 may be eliminated by expelling deionized water from the deionized water nozzle 19 and the processing solution nozzles 17, in addition to an up-and-down movement of the holding mechanism 30.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus for performing a processing of a substrate comprising:
a first processing bath for storing deionized water;
a second processing bath for storing a chemical solution;
a holding mechanism that has a plurality of holding grooves for holding a plurality of substrates, and that can shift from the inside of the second processing bath to the inside of the first processing bath, while holding a plurality of substrates by the holding grooves;
a first supply part for supplying deionized water into the first processing bath; and
a second supply part for expelling deionized water to the holding grooves of the holding mechanism present in the first processing bath.

2. The substrate processing apparatus according to claim 1, further comprising:
a holding part that is disposed above the second supply part in the first processing bath, and that holds a plurality of substrates transferred from the holding mechanism, wherein
with a plurality of substrates held by the holding part, the second supply part expels deionized water to the holding grooves of the holding mechanism.

3. The substrate processing apparatus according to claim 1, further comprising:
a holding part that is disposed in the first processing bath and holds a plurality of substrates transferred from the holding mechanism, wherein
with a plurality of substrates held by the holding part, the second supply part can expel deionized water from an upper side of the holding grooves of the holding mechanism to the holding grooves.

4. The substrate processing apparatus according to claim 3, wherein the second supply part is disposed at the holding part.

5. The substrate processing apparatus according to claim 1, wherein the second supply part expels deionized water to the holding grooves of the holding mechanism before supplying deionized water from the first supply part to the first processing bath.

6. The substrate processing apparatus according to claim 1, wherein the second supply part expels deionized water to the holding grooves of the holding mechanism when supplying deionized water from the first supply part to the first processing bath.

7. The substrate processing apparatus according to claim 1, wherein the second supply part expels deionized water to the holding grooves of the holding mechanism in a state in which the holding mechanism holding a plurality of substrates is immersed in deionized water stored in the first processing bath.

8. A substrate processing apparatus for performing a processing of a substrate comprising:
a processing bath for storing a processing solution;
a holding mechanism that has a plurality of holding grooves for holding a plurality of substrates and is contained in the processing bath;
a first supply part for supplying a processing solution into the processing bath; and
a second supply part for expelling a processing solution to the holding grooves of the holding mechanism present in the processing bath.

9. The substrate processing apparatus according to claim 8, further comprising:
a holding part that is disposed above the second supply part in the processing bath, and that holds a plurality of substrates transferred from the holding mechanism, wherein
with a plurality of substrates held by the holding part, the second supply part expels a processing solution to the holding grooves of the holding mechanism.

10. The substrate processing apparatus according to claim 8, further comprising:
a holding part that is disposed in the processing bath and holds a plurality of substrates transferred from the holding mechanism, wherein
with a plurality of substrates held by the holding part, the second supply part can expel deionized water from an upper side of the holding grooves of the holding mechanism to the holding grooves.

11. The substrate processing apparatus according to claim 10, wherein the second supply part is disposed at the holding part.

12. The substrate processing apparatus according to claim 8, wherein the second supply part expels a processing solution to the holding grooves of the holding mechanism before supplying a processing solution from the first supply part to the processing bath.

13. The substrate processing apparatus according to claim 8, wherein the second supply part expels a processing solution to the holding grooves of the holding mechanism when supplying a processing solution from the first supply part to the processing bath.

14. The substrate processing apparatus according to claim 8, wherein the second supply part expels a processing solution to the holding grooves of the holding mechanism in a state in which the holding mechanism holding a plurality of substrates is immersed in a processing solution stored in the processing bath.

15. The substrate processing apparatus according to claim 8, wherein
the processing solution is deionized water,
the first supply part can supply a chemical solution to the processing bath, and
after the holding mechanism holding a plurality of substrates is immersed in a chemical solution supplied from the first supply part to the processing bath, a processing of the plurality of substrates is carried out with deionized water supplied from the first supply part.

16. A substrate processing apparatus for performing a processing of a substrate comprising:
a first processing bath for storing deionized water;
a second processing bath for storing a chemical solution;
a holding mechanism that has a plurality of holding grooves for holding a plurality of substrates, that can shift from the inside of the second processing bath to the inside of the first processing bath, while holding a plurality of substrates held by the holding grooves, and that can move up and down in the first processing bath;
a supply part for supplying deionized water into the first processing bath; and
a holding part that is disposed above the supply part in the first processing bath, and that holds a plurality of substrates transferred from the holding mechanism, wherein
with the holding mechanism holding a plurality of substrates immersed in deionized water stored in the first processing bath, a state in which a plurality of substrates are held by the holding grooves of the holding mechanism, and a state in which they are held by the holding part are repeated by allowing the holding mechanism to move up and down.

17. A substrate processing apparatus for performing a processing of a substrate comprising:
a processing bath for storing a processing solution;
a holding mechanism that has holding grooves for holding a plurality of substrates and can move up and down in the processing bath;
a supply part for supplying a processing solution into the processing bath; and
a holding part that is disposed above the supply part in the processing bath, and that holds a plurality of substrates transferred from the holding mechanism, wherein
with the holding mechanism holding a plurality of substrates immersed in a processing solution stored in the processing bath, a state in which a plurality of substrates are held by the holding grooves of the holding mechanism, and a state in which they are held by the holding part are repeated by allowing the holding mechanism to move up and down.

18. The substrate processing apparatus according to claim 17, wherein
the processing solution is deionized water,
the supply part can supply a chemical solution to the processing bath, and
after the holding mechanism holding a plurality of substrates is immersed in a chemical solution supplied from the supply part to the processing bath, a processing of a plurality of substrates is carried out with deionized water supplied from the supply part.
